(19) United States
(12) Patent Application Publication
(10) Pub. No.: US 2009/0192981 A1
(43) Pub. Date: Jul. 30, 2009

(54) Query Deployment Plan For A Distributed Shared Stream Processing System

(76) Inventors: Olga Papaemmanouil, Providence, RI (US); Sujoy Basu, Sunnyvale, CA (US); Sujata Banerjee, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/244,878

(22) Filed: Oct. 3, 2008

Related U.S. Application Data
(60) Provisional application No. 61/024,300, filed on Jan. 29, 2008.

(51) Int. Cl. G06F 17/30

(52) U.S. Cl. 707/2; 707/E17.017

(57) ABSTRACT

A method of providing a deployment plan for a query in a distributed shared stream processing system includes storing a set of feasible deployment plans for a query that is currently deployed in the stream processing system. A query includes a plurality of operators hosted on nodes in the stream processing system providing a data stream responsive to a client request for information. The method also includes determining whether a QoS metric constraint for the query is violated, and selecting a deployment plan from the set of feasible deployment plans to be used for providing the query in response to determining the QoS metric constraint is violated.

### CROSS-REFERENCE TO RELATED APPLICATION

The present application claims priority from provisional application Ser. No. 61/024,300, filed Jan. 29, 2008, the contents of which are incorporated herein by reference in their entirety.

### BACKGROUND

Over the past few years, stream processing systems (SPSs) have gained considerable attention in a wide range of applications including planetary-scale sensor networks or “macroscopes”, network performance and security monitoring, multi-player online games and feed-based information mash-ups. These SPSs are characterized by a large number of geographically dispersed entities, including data publishers that generate potentially large volumes of data streams and clients that register a large number of concurrent queries over these data streams. For example, the clients send queries to the data publishers to receive certain processing results.

SPSs should provide high network and workload scalability to be able to provide the clients with the requested data streams. The high network scalability refers to the ability to gracefully deal with an increasing geographical distribution of system components, whereas the workload scalability addresses a large number of simultaneous user queries. To achieve both types of scalability, the SPSs should be able to scale out and distribute its processing across multiple nodes in the network.

Distributed versions of SPSs have been proposed, but deployment of these distributed SPSs can be difficult. The difficulties associated with deploying SPSs is further exasperated when the deployment is for SPSs handling stream-based queries in shared processing environments, where applications share processing components. First, applications often express Quality-of-Service (QoS) specifications which describe the relationship between various characteristics of the output and its usefulness, e.g., utility, response delay, end-to-end loss rate or latency, etc. For example, in many real-time financial applications, query answers are only useful if they are timely received. When a data stream carrying the financial data is processed across multiple machines, the QoS of providing the data stream is affected by each of the multiple machines. Thus, if some of the machines are over-loaded, these machines will have an impact on the QoS of providing the data stream. Moreover, stream processing applications are expected to operate over the public Internet, with a large number of unreliable nodes, some or all of which may contribute their resources only on a transient basis, such as the case in peer-to- peer settings. Furthermore, stream processing and delivery of data streams to clients may require multiple nodes working in a chain or tree to process and deliver the streams, where the output of one node is the input to another node. Thus, if processing is moved to a new node in the network, the downstream processing in the chain or tree and QoS may be affected. For example, if processing is moved to a new node in a new geographic location, it may increase the end-to-end latency to a point that it is unacceptable for a client.

### BRIEF DESCRIPTION OF DRAWINGS

The embodiments of the invention will be described in detail in the following description with reference to the following figures.

FIG. 1 illustrates a system, according to an embodiment;

FIG. 2 illustrates data streams in the system shown in FIG. 1, according to an embodiment;

FIG. 3 illustrates overlay nodes in the system, examples of queries in the system, and examples of candidate hosts for operators, according to an embodiment;

FIG. 4 illustrates a flowchart of a method for initial query placement, according to an embodiment;

FIG. 5 illustrates a flowchart of method for optimization, according to an embodiment;

FIG. 6 illustrates a flowchart of a method for deployment plan generation, according to an embodiment;

FIG. 7 illustrates a flowchart of a method for resolving conflicts, according to an embodiment; and

FIG. 8 illustrates a block diagram of a computer system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

According to an embodiment a distributed SPS (DSPS) provides distributed stream processing across multiple overlay nodes in an overlay network. Nodes and overlay nodes are used interchangeably herein. The DSPS processes and delivers data streams to clients. A data stream comprises a feed of data. For example, a data stream may comprises an RSS feed or a stream of real-time financial data. The data stream may also include multi-media. A data stream may comprises a continuous or periodic transmission of data (such as real-time quotes or an RSS feed), or a data stream may include a set of data that is not necessarily continuously or periodically transmitted, such as results from a request for apartment listings. It should be noted that the stream processing performed by the DSPS includes shared stream processing, where an operator may be shared by multiple data streams as described below.

The DSPS includes an adaptive overlay-based framework that distributes stream processing queries across multiple available nodes. The nodes self-organize using a distributed resource directory service. The resource directory service is used for advertising and discovering available computer resources in the nodes.

The DSPS provides data stream deployments of multiple, shared, stream-processing queries while taking into consideration the resource constraints of the nodes and QoS expectations of each application (e.g., data stream), while maintaining a low bandwidth consumption. According to an embodiment, the DSPS uses a proactive approach, where nodes periodically collaborate to pre-compute alternative deployment plans of data streams. Deployment plans are also referred to as plans herein. During run time, when a computer resource or QoS metric constraint violation occurs, the DSPS can react fast to changes and migrate to a feasible deployment plan by applying the most suitable of the pre-computed deployment plans. Moreover, even in the absence of any violations, the best of these plans can be applied to periodically improve the bandwidth consumption of the system.

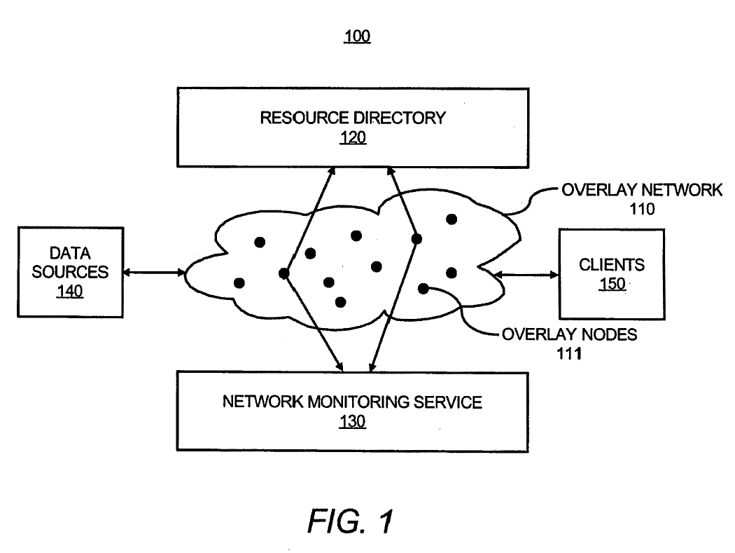

FIG. 1 illustrates a streams processing system 100, according to an embodiment. The system 100 includes an overlay network 110 comprised of overlay nodes 111, a resource directory 120 and a network monitoring service 130.

The overlay network 110 includes an underlying network infrastructure including computer systems, routers, etc., but the overlay network 110 provides additional functionality with respect to stream processing, including stream-based query processing services. For example, the overlay network 110 may be built on top of the Internet or other public or private computer networks. The overlay network 110 is comprised of the overlay nodes 111, which provide the stream processing functionality. The overlay nodes 111 are connected with each other via logical links forming overlay paths, and each logical link may include multiple hops in the underlying network.

According to an embodiment, the overlay nodes 111 are operable to provide stream-based query processing services. For example, the overlay nodes 111 include operators for queries. A query includes a plurality of operators hosted on nodes in the stream processing system. The query may be provided in response to receiving and registering a client query or request for information. An operator is a function for a query. An operator may include software running on a node that is operable to perform the particular operation on data streams. A portion of an overlay node's computer resources may be used to provide the operator for the query. The overlay node may perform other functions, thus the load on the overlay node may be considered when selecting an overlay node to host an operator.

Examples of operators include join, aggregate, filter, etc. The operators may include operators typically used for queries in a conventional database, however, the operators in the system 100 operate on data streams. Operators may be shared by multiple queries, where each query may be represented by one or more data streams. Also, subqueries are created by operators. In one sense, any query consisting of multiple operators has multiple subqueries, one for each operator, even if the query is for a single client. In another sense, when a new query from another client can use the result of a previous query as a partial result, the previous query becomes a subquery of the new one. For example, regarding the situation where a previous query may be partially used for a new query, a filter operation may be executed by a node on a data stream representing the results of a previous request. For example, an original client query may request all the apartment listings in northern California, and a filter operation may be performed at a node to derive the listings only for Palo Alto.

A join operation is a join of two tables in a conventional database, such as a join of addresses of employees and employee IDs. The same operation is applied to data streams except for data streams with continuous or periodically transmitted data, a sliding window is used to determine where to perform the join in the stream. For example, the join operator has a first stream that is one input and a second stream that is another input. The join is performed if data from the streams have timestamps within the sliding window. An example of a sliding window may be a 2-minute window, but other length windows may be used.

Operators may be assigned at different overlay nodes and may be reallocated over time as the distribution of queries across the network is optimized. Optimization may take into consideration several types of metrics. The types of metrics may include node-level metrics, such as CPU utilization, memory utilization, etc., as well as service provider metrics, such as bandwidth consumption, etc. Also, QoS metrics, such as latency are considered. Optimization is described in further detail below.

Client queries for data may be submitted to the overlay network 110. The location of operators for the query define the deployment plan of the query, which is also described in further detail below. Depending on the resources available in the network and the query's requirements, each query could have multiple alternative precomputed deployment plans. The operators of a query are interconnected by overlay links between the nodes 111 in the overlay network 110. Each operator forwards the output of an operator to the next processing operator in the query plan. Thus, query deployments create an overlay network with a topology consistent with the data flow of the registered queries. If an operator oᵢ forwards its output to an operator oⱼ, oᵢ is referred to as the upstream operator of oⱼ (or its publisher) and to oⱼ as the downstream operator of oᵢ (or its subscriber). Operators could have multiple publishers (e.g., join, union operators) and since they could be shared across queries they could also have multiple subscribers. The set of subscribers of oᵢ is denoted as subₒᵢ and its set of publishers as pubₒᵢ.

The system 100 also includes data sources 140 and clients 150. The data sources 140 publish the data streams while clients subscribe their data interests expressed as stream-oriented continuous queries. The system 100 streams data from publishers to clients via the operators deployed in the overlay nodes 111. Examples of published data streams may include RSS feeds, data from sensor networks, data from multi-player games played over the Internet, etc.

Creating deployment plans for queries includes identifying operators to be hosted on overlay nodes for deploying the queries. To discover potential overlay nodes for hosting the operators, a resource directory 120 is used. The resource directory 120 may be a distributed service provided across multiple overlay nodes. In one embodiment, the resource directory 120 is based on the NodeWiz system described in Basu et al., “Nodewiz: Peer-to-peer resource discovery for grids.” The Nodewiz system is a scalable tree-based overlay infrastructure for resource discovery.

The overlay nodes 110 use the resource directory 120 to advertise the attributes of available computer resources of each node and efficiently perform multi-attribute queries to discover the advertised resources. For example, each overlay node sends its available computer resource capacity to the resource directory 120, and the resource directory 120 stores this information. Examples of capacity attributes include CPU capacity, memory capacity, I/O capacity, etc. Also, during optimization, an overlay node or some other entity may send queries to the resource directory 120 to identify an overlay node with predetermined available capacity that can be used to execute a relocated operator. The resource directory 120 can adapt the assignment of operators such that the load of distributing advertisements and performing queries is balanced across nodes.

A network monitoring service 130 collects statistics of the overlay links between the overlay nodes 111. One example of statistics includes latency statistics. The network monitoring service 130 may be based on S3 described in Yalagandula et al., “s3: A scalable sensing service for monitoring large networked systems.” The network monitoring service 130 is a scalable sensing service for real-time and configurable monitoring for large networked systems. The infrastructure, which may include the overlay nodes 111, can be used to measure QoS, node-level, and service provider metrics, while it aggregates data in a scalable manner. Moreover, inference algorithms can be used to derive path properties of all pairs of nodes based on a small set of network paths. During optimization, the network monitoring service 130 can be queried to identify end-to-end overlay paths or overlay links between nodes that provide the pre-requisite QoS, e.g., a path that has a latency less than a threshold.

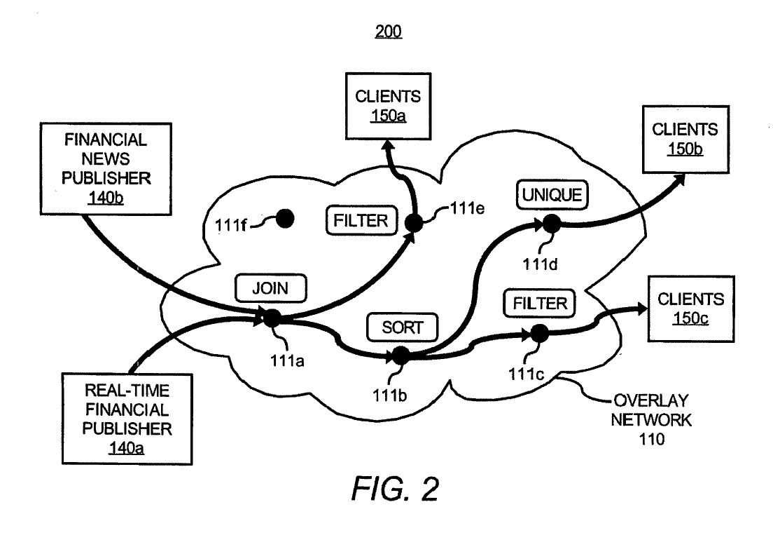

FIG. 2 illustrates an example of deploying data streams. For example, the real-time financial publisher 140a generates a data stream with real-time stock quotes in response to one or more client queries. A financial news publisher 140b also generates a data stream of financial news. The operators at nodes 111a-e function to provide subqueries by executing their respective operators to provide the clients with the desired data. For example, the clients 150a-c want stock quotes and corresponding financial news for different companies, and the clients 150b and 150c require a particular sorting of the data streams. The operators execute subqueries on the original data streams from the publishers to provide the desired data to the clients.

During optimization, it may be determined that the join operator needs to be moved from the node 111a because the node 111a is overloaded or there is a QoS metric constraint violation. The join operator may be moved to the node 111f, but the downstream operators will be affected. Optimization pre-computes feasible deployment plans that will not violate QoS metric constraints or computer resource capacities of nodes.

The system 100 implements an optimization protocol that facilitates the distribution of operators among nodes in the overlay network, such that QoS expectations for each query and respective resource constraints of the nodes are not violated. The optimization includes pre-computing alternative feasible deployment plans for all registered queries. Each node maintains information regarding the placement of its local operators and periodically collaborates with nodes in its “close neighborhood” to compose deployment plans that distribute the total set of operators. A deployment plan identifies operators and nodes to host operators providing an end-to-end overlay path for a data stream from publisher to client.

Whenever a computer resource or QoS metric constraint violation occurs for an existing deployment plan, the system can react fast by applying the most suitable plan from the pre-computed set. Moreover, even in the absence of violations, the system can periodically improve its current state by applying a more efficient deployment than the current one.

The optimization process includes proactive, distributed, operator placement which is based on informing downstream operators/nodes about the feasible placements of their upstream operators. This way the overlay nodes can make decisions regarding the placement of their local and upstream operators that will influence their shared queries the best way possible. One main advantage of this approach is that nodes can make placement decisions on their own, which provides fast reaction to any QoS metric constraint violations.

Each operator periodically sends deployment plans to its subscribed downstream operators describing possible placements of their upstream operators. These plans are referred to as partial, since they only deploy a subset of a query's operators. When a node receives a partial plan from an upstream node, it extends the plan by adding the possible placements of their upstream operator. Partial plans that meet the QoS constraints of all queries sharing the operators in the plan are propagated to other nodes.

To identify feasible deployment plans, a k-ahead search is performed. The k-ahead search discovers the placement of k operators ahead from the local operator that for example incurs the lowest latency. Instead of latency other QoS metrics may be used. Based on the minimum latency, partial plans that could violate a QoS bound (e.g., a latency greater than a threshold) are eliminated as early in the optimization process as possible. Also, every node finalizes its local partial plans. This may include each node evaluating its impact on the bandwidth consumption and the latency of all affected queries. Using the final plans, a node can make fast placement decisions in run-time.

It should be noted that several types of metrics may be employed to select a deployment plan. For example, one or more QoS metrics provided by a client, such as end-to-end latency, and one or more node-level metrics, such as available capacity of computer resources, can be used to determine whether a path is a feasible path when selecting a set of alternative feasible deployment plans. Also, another type of metric, e.g., a service provider metric, such as minimum total bandwidth consumption, consolidation, etc., can be used to select one of the paths from the set of feasible deployment plans to deploy for the data stream. The optimization process is now described in detail and symbol definitions in table 1 below are used to describe the optimization process.

TABLE 1
Symbol Definitions

| Symbol | Definition |
|---|---|
| ocₒᵢ | cost of operator oᵢ |
| roᵢⁱⁿ | input rate of operator oᵢ |
| QoS_{q}ₜ | QoS of query qₜ |
| d_{q}ₜ | response latency of query qₜ |
| subₒᵢ | subscribers (downstream operators) of oᵢ |
| pubₒᵢ | publishers (upstream operators) of oᵢ |
| h(oᵢ) | host node of operator oᵢ |
| cᵢ | capacity of node nᵢ |
| Oₙᵢ | set of operators hosted on nᵢ |
| Qₒᵢ | set of queries sharing operator oᵢ |
| Aₒᵢ | candidate hosts of operator oᵢ |
| Pₒᵢ | upstream operators of oᵢ |
| O(qᵢ) | set of operators in query qᵢ |

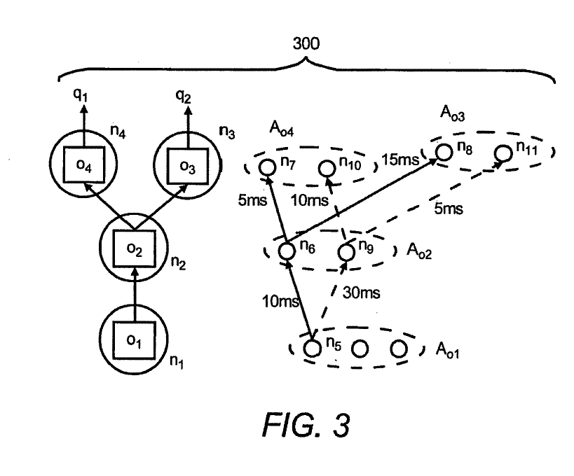

Each overlay node periodically identifies a set of partial deployment plans for all its local operators. Assume an operator oᵢ is shared by a set of queries q, εQₒ_{ᵢ}. Let also Pₒ_{ⱼ} be the set of upstream operators for oᵢ. An example is shown in FIG. 3. Queries q₁ and q₂ share operators o₁ and o₂ and Pₒ₃=Pₒ₄={o₁,o₂}.

A partial deployment plan for oᵢ assigns each operator oⱼεoⱼεPₒ_{ᵢ}∪(oᵢ) to one of the overlay nodes in the network. Each partial plan p is associated with (a) a partial cost, pc^{p}, e.g., the bandwidth consumption it occurs, and (b) a partial latency for each query it affects, pl_{qt}^{p},∀qₜεQₒᵢ. For example, a partial plan for o₂ will assign operators o₁ and O₂ to two nodes, evaluate the bandwidth consumed due to these placements, and the response latency up to operator o₂ for each query q₁ and q₂.

FIG. 3 also shows candidate nodes, candidate links and latencies for the links which are evaluated when determining whether the node links can be used as part of a feasible deployment plan. The evaluation of candidate nodes and QoS metrics (e.g., latency) for deployment plan generation is described in further detail below.

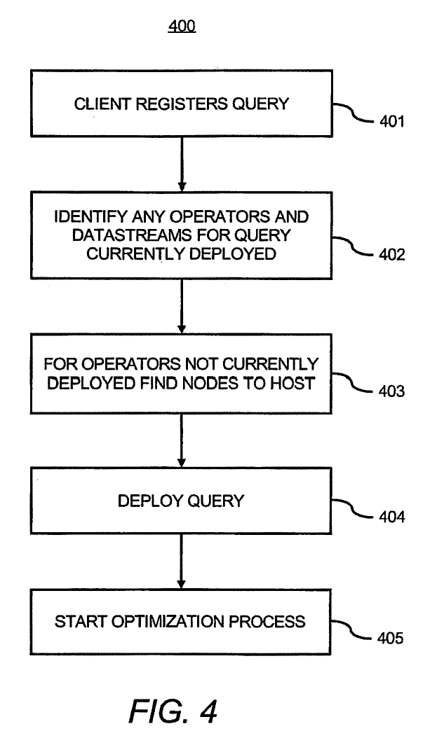

FIG. 4 illustrates a method 400 for initial placement of a query, according to an embodiment. At step 401 a client registers a query. For example, the client 150a shown in FIG. 2 sends a client query to the publishers 140a and 140b requesting stock quotes and related financial news.

At step 402, any operators and data streams for the query that are currently deployed are identified. The resource directory 120 shown in FIG. 2 may be used to store information about deployed operators and streams.

At step 403, for any operators that do not exist, a node is identified with sufficient computer resource capacity that are closest to the publisher or their publisher operator to host the operator. Note that this is for initial assignment of nodes/initial placement of a query. Other nodes that may not be closest to the publisher or their publisher operator may be selected for optimization.

At step 404, the query is deployed using the operators and data streams, if any, from step 402 and the operators, if any, from step 403. For example, the data stream for the query is sent to the client registering the query.

At step 405, the optimization process is started. The optimization process identifies deployment plans that may be better than the current deployment plan in terms of one or more metrics.

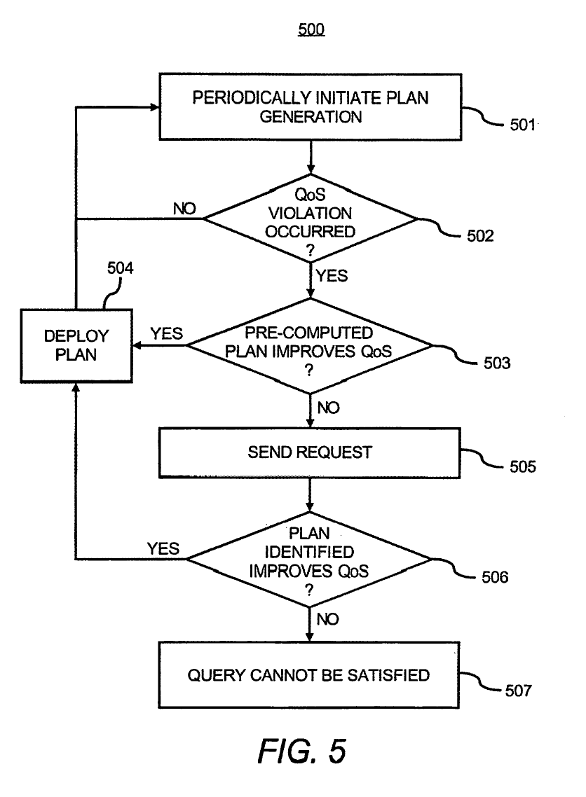

FIG. 5 illustrates a method 500 for the optimization process, according to an embodiment One or more of the steps of the method 500 may be performed at step 405 in the method 400.

At step 501, a plan generation process is periodically initiated. This process creates feasible deployment plans that reflect the most current node workload and network conditions. These pre-computed deployment plans are stored on the overlay nodes and may be used when a QoS violation is detected or if a determination is made as to whether bandwidth consumption or another metric may be improved by deploying one of the precomputed plans. The plan generation process is described in further detail below with respect to the method 600.

At step 502, nodes determine whether a QoS metric constraint violation occurred. For example, a QoS metric, such as latency, is compared to a threshold, which is the constraint. If the threshold is exceeded, then a QoS violation occurred.

To detect these violations, every overlay node monitors for every local operator the latency to the location of its publishers. It also periodically receives the latency of all queries sharing its local operators, and it quantifies their “slack” from their QoS expectations, i.e., the increase of latency each query can tolerate. For example, assume an operator oᵢ with a single publisher oₘ and shared by a query qt with a response delay d_{qt} and slack slack_{qt}. If the latency of the overlay link between oᵢ and oₘ increases by Δd(h(oₘ), h(oᵢ))>slack_{qt}, then the QoS of the query qt is violated and a different deployment should be applied immediately.

At step 503, if a QoS violation occurred, determine whether one of the pre-computed plans can be used to improve the QoS. The plan should improve the QoS sufficiently to remove the QoS violation.

Across all final plans stored at the host of oᵢ, a search is performed for the a plan p that decreases qt's latency by at least Δpl_{qt}^{p}=d_{qt}−QoS_{qt}. Across all plans that satisfy this condition, any plan p is removed that does not migrate oᵢ and oₘ (i.e., includes the bottleneck link) and satisfies

Δpl_{qt}^{p}+Δd(h(oₘ),h(oᵢ))≦QoS_{qt}−d_{qt}.

If a precomputed plan exists that can be used to improve the QoS, then the pre-computed plan is deployed at step 504. For example, as described above any plan p is removed that does not migrate oᵢ and oₘ (i.e., includes the bottleneck link) and satisfies Δpl_{qt}^{p}+Δd(h(oₘ),h(oᵢ))≦QoS_{qt}−d_{qt}. From the remaining plans, one plan is applied that most improves the bandwidth consumption.

Otherwise, as step 505, a request is sent to other nodes for a feasible plan that can improve the QoS. For example, the request is propagated to its downstream subscriber/operator. That is, if a deployment that can meet qₜ's QoS cannot be discovered at the host of oᵢ the node sends a request for a suitable plan to its subscriber for the violated query qₜ. The request includes also metadata regarding the congested link (e.g., its new latency). Nodes that receive such requests, attempt to discover a plan that can satisfy the QoS of the query qₜ. Since downstream nodes store plans that migrate more operators, they are more likely to discover a feasible deployment for qₜ. The propagation continues until we reach the node hosting the last operator of the violated query.

At step 506, a determination is made as to whether a plan can be identified in response to the request. If a plan cannot be identified, the query cannot be satisfied at step 507. The client may be notified that the query cannot be satisfied, and the client may register another query. Otherwise, a plan identified in response to the request that can improve the QoS sufficiently to remove the QoS violation is deployed.

It is important to note that identifying a new deployment plan has a small overhead. Essentially, nodes have to search for a plan that reduces enough the latency of a query. Final plans can be indexed based on the queries they affect and sorted based on their impact on each query's latency. Thus, when a QoS violation occurs, our system can identify its “recovery” deployments very fast.

At steps 502-507, a new plan may be deployed in response to a QoS violation. Many of these steps may also be deployed when a QoS violation has not occurred, but a determination is made that a new plan can provide better QoS, or better node-level (e.g., computer resource capacity) or service provider metrics (e.g., bandwidth consumption) than an existing plan.

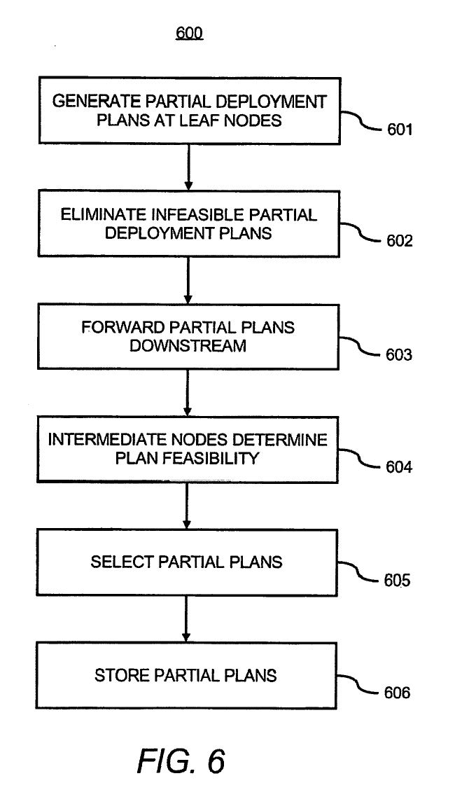

FIG. 6 illustrates a method 600 for deployment plan generation, according to an embodiment. One or more of the steps of the method 600 may be performed at step 501 in the method 500 as the plan generation process.

A k-ahead search may be performed before the method 600 and is described in further detail below. The k-ahead search makes each node aware of candidate hosts for local operators that can be used for partial deployment plans.

At step 601, partial deployment plans are generated at the leaf nodes. Let oᵢ be a leaf operator executed on a node nᵥ. Node nᵥ creates a set of partial plans, each one assigning oᵢ to a different candidate host nⱼεAₒ_{ᵢ} and evaluates its partial cost and the partial latencies of all queries sharing oᵢ. If Sₒ_{ᵢ} is the set of input sources for oᵢ, and h(s), sεSₒ_{ⱼ} is the node publishing data on behalf of source s, then, the partial latency (i.e., the latency from the sources to nⱼ) of a query qₜ is pl_{qt}^{p}=_{sεS}_{ₒⱼ}^{max}d(h(s),nⱼ),∀qₜεQₒ_{ⱼ}. Finally, since this plan assigns the first operator, its partial bandwidth consumption is zero.

At step 602, infeasible partial deployment plans are eliminated. Once a partial plan is created, a decision is made as to whether the partial plan should be forwarded downstream and expanded by adding more operator migrations. A partial plan is propagated only if it could lead to a feasible deployment. The decision is based on the results of the k-ahead search. The k-ahead latency for a triplet (oᵢ, nⱼ, qₜ) represents the minimum latency overhead for a query qₜ across all possible placements of k operators ahead of oᵢ, assuming oᵢ is placed on nⱼ. If the latency of the query up to operator oᵢ plus the minimum latency for k operators ahead violates the QoS of the query, the partial plan could not lead to any feasible deployments. More specifically, a partial plan p that places operator oᵢ to node nⱼ is infeasible if there exists at least one query qₜεQₒ_{ᵢ} such that pl_{qt}^{p}+γᵢ^{k}(nⱼ,qₜ)≦QoS_{qt}.

Note, that the k-ahead latency, although it does not eliminate feasible plans, it does not identify all infeasible deployments. Thus, the propagated plans are “potentially” feasible plans which may be proven infeasible in following steps.

Moreover, there is a tradeoff with respect to the parameter k. The more operators ahead that are searched, the higher the overhead of the k-ahead search, however, the earlier infeasible plans will be able to be discovered.

At step 603, partial plans that are not eliminated are forwarded downstream along with metadata for evaluating the impact of a new partial plan. These include the feasible partial deployment plans identified from step 602. The metadata may include partial latency and/or other metrics for determine plan feasibility.

Assume a node nᵥ, processing an operator oᵢ, receives a partial plan p from its publishers oₘεpubₒ_{ᵢ}. For purposes of illustration assume a single publisher but the equations below can be generalized for multiple publisher in a straightforward way. Note, that each query sharing oi is also sharing its publishers. Thus, each received plan includes a partial latency pl_{qt}^{p}∀qₜεQₒ_{ᵢ}. The optimization process expands each of these plans by adding migrations of the local operator o to its candidate hosts.

For each candidate host nⱼεAₒ_{ᵢ}, the node nᵥ validates the resource availability. For example, it parses the plan p to check if any upstream operators have also been assigned to nⱼ. To facilitate this, along with each plan metadata is sent on the expected load requirements of each operator included in each plan. If the residual capacity of nⱼ is enough to process all assigned operators including oᵢ, the impact of the new partial plan f is estimated as: pl_{qt}^{f}=d(h^{p}(oₘ),nⱼ)∀qₜεQₒ_{ᵢ} and pc^{f}=pc^{m}+rₒ_{ₘ}^{out}×φ(h^{p}(oₘ),nⱼ) where, h^{p}(oₘ) is the host of oₘ in the partial plan p. For each new partial plan f we also check if it could lead to a feasible deployment, based on the k-ahead latency γᵢ^{k}(nⱼ;qᵣ), and propagate only feasible partial plans.

At step 604, intermediate upstream nodes receiving the partial plans forwarded at step 603 determine the partial plan feasibility, as described above. For example, the intermediate node receiving the plan is a candidate for an operator of the query. The intermediate node validates its computer resource availability to host the operator and determines the impact on QoS if the node were to host the operator. At step 605, feasible partial plans are selected based on impact on a service provider metric, such as bandwidth consumption.

At step 606, the selected feasible partial plans are stored in the overlay nodes. For example, partial plans created on a node are “finalized” and stored locally. To finalize a partial plan its impact on the current bandwidth consumption and on the latency of the queries it affects is evaluated. To implement this process, statistics are maintained on the bandwidth consumed by the upstream operators of every local operator and the query latency up to this local operator. For example, in FIG. 3, if o₁ is a leaf operator, n₂ maintains statistics on the bandwidth consumption from o₁ to o₂ and the latency up to operator o₂. For each plan, the difference of these metrics between the current deployment and the one suggested by the plan are evaluated and stored as metadata along with the corresponding final plan. Thus, every node stores a set of feasible deployments for its local and upstream operators, along with the effect of these deployments on the system cost and the latency of the queries. In FIG. 3, n₂ stores plans that migrate operators {o₁, o₂}, while n₄ will store plans that place {o₁, o₂, o₄}.

Combining and expanding partial plans received from the upstream nodes may generate a large number of final plans. To deal with this problem, a number of elimination heuristics may be employed. For example, among final plans with similar impact on the query latencies the ones with the minimum bandwidth consumption are kept, while if they have similar impact on the bandwidth the ones that reduce the query latency the most are kept.

As described above, nodes perform a k-ahead search to identify candidate hosts for local operators. At step 601, the leaf nodes create partial plans. Partial plans may be created using a k-ahead search.

In the k-ahead search, every node nᵥ runs the k-ahead search for each local operator oᵢεOₙ, and each candidate host for that operator. If Aₒ_{ᵢ} is the set of candidate hosts for oᵢ, the search identifies the minimum latency placement of k operators ahead of oᵢ for each of the queries sharing oᵢ, assuming that oᵢ is placed on the node nⱼεAₒ_{ᵢ}. Intuitively, the search attempts to identify the minimum impact on the latency of each query qₜεQₒ_{ᵢ}, if migrating oᵢ to node nⱼ makes the best placement decision (e.g., with respect to latency) for the next k downstream operators of each query qt. Below the steps of the k-ahead search are described, which initially evaluates the 1-ahead latency and then derives the k-ahead latency value for every triplet (oᵢ, nⱼ, qₜ), where oᵢεOₙ, nⱼεAₒ_{ᵢ}, qₜεQₒ_{ᵢ}.

For each operator oᵢεOₙ_{ᵥ}, nᵥ executes the following steps:

1. Identifies the candidate hosts Aₒ_{ᵢ} of the local operator oᵢ by querying the resource directory service. Assuming the constraint requirements of oᵢ are C=[(c₁, v₁), (c₂, v₂), . . . , (cₘ, vₘ)], where cᵢ is the resource attribute and vi is the operator's requirement for that resource, the resource directory is queried for nodes with c₁≧v₁Λc₂≧v₂Λ . . . cₘ≧vₘ.

2. If oₘ is the downstream operator of oᵢ for the query qₜεQₒ_{ᵢ}, the node sends a request to the host of oₘ, asking for the set of candidate hosts Aₒ_{ₘ} of that operator. For each one of these candidate nodes, it queries the networking monitoring service for the latency d(nⱼ, nₜ), ∀nⱼεAₒ_{ᵢ},∀nₜεAₒ_{ₘ}. The 1-ahead latency for the oi operator with respect to its candidate nⱼ and the query qₜεQₒ_{ᵢ} is

$${γ}_{i}^{1} ( {n}_{j} , {q}_{t} ) = \begin{matrix}min \\ {n}_{t ∈ {A}_{{o}_{m}}}\end{matrix} \{ d ( {n}_{j} , {n}_{t} ) \} .$$

In FIG. 3, subₒ_{₂}^{q}^{ₜ}=o₄,subₒ₂^{q}^{ₜ}=o₃ and n₁ will request from n₂ the candidate hosts Aₒ_{₂} for the operator o₂, and will estimate the 1-ahead latencies γ₁¹(n₄,q₁)=γ₁¹(n₅,q₂)=10 ms. Also for o₂ we assume γ₂¹(n₆,q₁)=5 ms and γ₂¹(n₆,q₂)=15 ms.

3. The search continues in rounds, where for each operator oᵢ the node waits for it subscribers oₘ in the query qₜεQₒ_{ᵢ} to complete the evaluation of the (k-1)-ahead latency before they proceed with the estimation of the k-ahead latency. The k-ahead latency for the oᵢ operator with respect to its candidate nⱼ and the query

$$qt ∈ {Q}_{{o}_{i}} is {γ}_{i}^{k} ( {n}_{j} , {q}_{t} ) = \begin{matrix}min \\ {n}_{t ∈ {A}_{{o}_{m}}}\end{matrix} \{ {γ}_{i}^{k} ( {n}_{t} , {q}_{t} ) + d ( {n}_{j} {n}_{t} ) \} .$$

The last step is described using the example in FIG. 3. In this case, γ₁²(n₅,q2)=min{(10+{γ₂¹(n₆,q₂),30+γ₂¹(n₉,q₂)}=25 ms. Thus, assuming migration of o₁ to n₅, the placement with the minimum latency of the next two operators will increase the partial response latency of q₁ by 15 ms and the partial latency of q₂ by 25 ms, where each partial latency increases as more operators are assigned to the query.

Concurrent modifications of shared queries require special attention, as they could create conflicts with respect to final latency of their affected queries. For example, in FIG. 3, assume that the QoS of both q₁ and q₂ are not met, and nodes n₃ and n₄ decide concurrently to apply a different deployment plan for each query. Parallel execution of these plans does not guarantee that their QoS expectations will be satisfied.

To address the problem, operators may be replicated. Deployment plans are implemented by replicating the operators whenever migrating them cannot satisfy the QoS metric constraints of all their dependent queries. However, replicating processing increases the bandwidth consumption as well as the processing load in the system. Hence, a process identifies if conflicts could be resolved by alternative candidate plans, and if none is available, then it applies replication. The process uses the metadata created during the plan generation phase to identify alternative to replication solutions. More specifically, it uses the existing deployment plans to (1) decide whether applying a plan by migration satisfies all concurrently violated queries; (2) allow multiple migrations whenever safe, i.e., allow for parallel migrations; and (3) build a non-conflicting plan when the existing ones can cannot be used. In the next paragraph the process is described using the following definitions.

Definition for Direct Dependencies: Two queries qᵢ and qⱼ are directly dependent if they share an operator, i.e., ∃oₖ such that qᵢεQ(oₖ) and qⱼεQ(oₖ). Then, qᵢ and qⱼ are dependent queries of every operator oₖ. Note that the set of dependent queries of a query qᵢ is D_{qi} and the dependent queries of an operator oₖ is Dₒₖ. Then, if O(qᵢ) is the set of operators in query qᵢ, D_{qi}=Yₒ_{_{keo(qt)}}Dₒₖ.

Directly dependent queries do not have independent plans, and therefore concurrent modifications of their deployment plans require special handling to avoid any conflicts and violation of the delay constraints.

Definition for Indirect Dependencies: Two queries qᵢ and qⱼ are indirectly dependent iffO(qᵢ∩qⱼ)=Ø and Dₒ_{ᵢ}IDₒⱼ≠Ø.

Indirectly dependent queries have independent (non-overlapping) plans. Nevertheless, concurrent modifications on their deployment plans could affect their common dependent queries. Hence, the process addresses these conflicts as well, insuring that the QoS expectations of the dependent queries are satisfied. To detect concurrent modifications, a lease-based approach is used. Once a node decides that a new deployment should be applied, all operators in the plan and their upstream operators are locked. Nodes trying to migrate already locked operators check if their modification does not conflict with the current one in progress. If a conflict exists, it tries to identify an alternative non-conflicting deployment. Otherwise, it applies its initial plan by replicating the operators. The lease-based approach is described in the next paragraphs.

Assume a node has decided on the plan p to apply for a query q. It forwards a REQUEST LOCK(q, p) message to its publishers and subscribers. In order to handle indirect dependencies, each node that receives the lock request, will also send it to the subscribers of its local operator of the query q. This request informs nodes executing any query operators and their dependents about the new deployment plan and request the lock of q and its dependents. Given that no query has the lock (which is always true for queries with no dependents), publishers/subscribers reply with a MIGR LEASE(q) grant, once they receive a MIGR LEASE(q) request from their own publisher/subscriber of that query. Nodes that have granted a migration lease are not allowed to grant another migration lease until the lease has been released (or expired, based to some expiration threshold).

Once node n receives its migration lease from all its publishers and subscribers of q, it applies the plan p for that query. It will parse the deployment plan and for every node hosting a migrating operator o to node n sends a MIGRATE(o, n) message. Migration is applied in a top-down direction of the query plan, i.e., the most upstream nodes migrate their operator (if required by the plan) and once this process is completed the immediate operators are informed about the change and subscribe to the new location of the operators. As nodes update their connections, they apply also any local migration specified by the plan. Once the whole plan is deployed then a RELEASE LOCK(q) request is forwarded to the old locations of the operators and their dependents, which release the lock for the query.

A lock request is sent across all nodes hosting operators included in the plan and all queries sharing operators of the plan. Once the lock has been granted any following lock requests will be satisfied either by replication or migration lease. A migration lease allows the deployment plan to be applied by migrating its operators. However, if such a lease cannot be granted due to concurrent modifications on the query network, a replication lease can be granted, allowing the node to apply the deployment plan of that query by replicating the involved operators. This way, only this specific query will be affected.

One property that should be noted is that if an operator oi is shared by a set of queries Dₒ_{ᵢ}, then the sub-plan rooted from oᵢ is also shared by the same set of queries. Now assume two dependent queries qᵢ and qⱼ that both have their QoS metric constraints violated. Query qᵢ sends the REQUESTLOCK(qi, pi) requests to this downstream operators and similarly for the query qⱼ. Moreover, shared operators that are aware of the dependencies forward the same request to their subscribers to inform also the dependent queries of the requested lock. Since queries share some operators, at least one operator will receive both lock requests. Upon receipt of the first requests it applies the procedure describe below, i.e., identifying conflicts and resolving them based on the metadata of the two plans. However, when the second request for a lock arrives the first shared node to receive does not forward it to any publishers as a migration lease for this query has already been granted.

The next paragraphs describe different cases encountered when trying to resolve conflicts for direct and indirect dependencies. For direct dependencies concurrent modifications on directly dependents plans are encountered.

Regarding parallel migrations, concurrent modifications are not always conflicting. If two deployment plans do not affect the same set of queries, then both plans can be applied in parallel. For example, in FIG. 3, if n₃ and n₄ decide to migrate only o₃ and o₄ respectively, both changes can be applied. In this case, the two plans decided by n₃ and n₄ should show no impact on the queries q₁ and q₂ respectively. The deployment plans include all the necessary information (operators to be migrated, new hosts, affect on the queries) to identify these cases efficiently, and thus grant migration leases to multiple non-conflicting plans.

Regarding redundant migrations, multiples migrations defined by concurrent deployment of multiple plans may often not be necessary in order to guarantee the QoS expectations of the queries. Very often, nodes might identify in parallel QoS violations and attempt to address them by applying their own locally stored deployment plans. In this case, it is quite possible that either one of the plans will be sufficient in order to reconfigure the current deployment. However, every plan includes an evaluation of the impact on all affected queries. Thus, if two plans P1 and P2 are both affecting the same set of queries, then applying either one will still provide a feasible deployment of our queries. Therefore, the plan that first acquires the migration lease is applied while the second plan is ignored.

Regarding alternative migration plans, deployments plans that relocate shared operators cannot be applied in parallel. In this case, the first plan to request the lock migrates the operators, while an attempt is made to identify a new alternative non-conflicting deployment plan to meet any unsatisfied QoS expectations. Since the first plan is migrating a shared operator, then hosts of downstream operators are searched for any plans that were built on top of this migration. For example, in FIG. 3, if the first plan migrates operator o₁, but the QoS of q₂ is still not met, the node n₄ is searched for any plans that include the same migration for o₁ and can reduce further q₂'s response delay by migrating o₄ as well.

Regarding indirect dependencies, queries may not share operators, but still share dependents. Thus, if an attempt is made to modify the deployment of indirectly dependent queries, the impact on their shared dependents is considered. In this case, a migration lease is granted to the first lock request and a replication lease to any following requests, if the plans to be applied are affecting overlapping sets of dependent queries. However, in the case where they do not affect the QoS of the same queries, these plans can be applied in parallel.

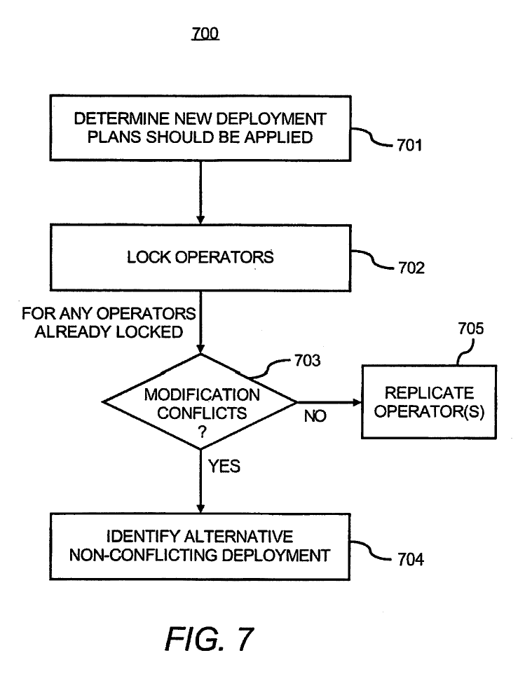

FIG. 7 illustrates a method 700 for concurrent modifications of shared queries. At step 701, a node determines that a new deployment plan should be applied, for example, due to a QoS metric constraint violation.

At step 702, all operators in the plan are locked unless the operators are already locked. If any operators are locked, a determination is made as to whether a conflict exists at step 703.

At step 704, if a conflict exists, the node tries to identify an alternative non-conflicting deployment.

At step 705, if a conflict does not exist, the node replicates the operator and applies its initial plan.

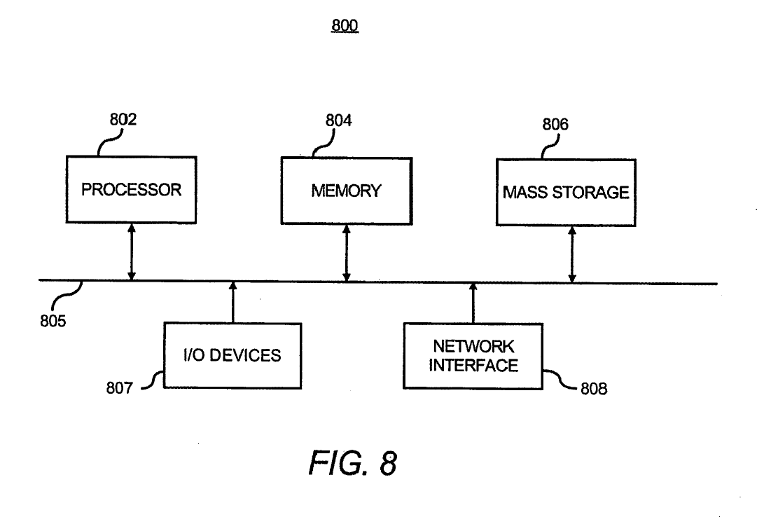

FIG. 8 illustrates an exemplary block diagram of a computer system 800 that may be used as a node (i.e., an overlay node) in the system 100 shown in FIG. 1. The computer system 800 includes one or more processors, such as processor 802, providing an execution platform for executing software.

Commands and data from the processor 802 are communicated over a communication bus 805. The computer system 800 also includes a main memory 804, such as a Random Access Memory (RAM), where software may be resident during runtime, and data storage 806. The data storage 806 includes, for example, a hard disk drive and/or a removable storage drive, representing a floppy diskette drive, a magnetic tape drive, a compact disk drive, etc., or a nonvolatile memory where a copy of the software may be stored. The data storage 806 may also include ROM (read only memory), EPROM (erasable, programmable ROM), EEPROM (electrically erasable, programmable ROM). In addition to software for routing and other steps described herein, routing tables, network metrics, and other data may be stored in the main memory 804 and/or the data storage 806.

A user interfaces with the computer system 800 with one or more I/O devices 807, such as a keyboard, a mouse, a stylus, display, and the like. A network interface 808 is provided for communicating with other nodes and computer systems.

One or more of the steps of the methods described herein and other steps described herein may be implemented as software embedded on a computer readable medium, such as the memory 804 and/or data storage 806, and executed on the computer system 800, for example, by the processor 802. The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions. While the embodiments have been described with reference to examples, those skilled in the art will be able to make various modifications to the described embodiments without departing from the scope of the claimed embodiments.

What is claimed is:

1. A method of providing a deployment plan for a query in a distributed shared stream processing system, the method comprising:
storing a set of pre-computed feasible deployment plans for a query that is currently deployed in the stream processing system, wherein a query includes a plurality of operators hosted on nodes in the stream processing system providing a data stream responsive to a client request for information;
determining whether a QoS metric constraint for the query is violated; and
selecting a deployment plan from the set of feasible deployment plans to be used for providing the query in response to determining the QoS metric constraint is violated.

2. The method of claim 1, wherein storing a set of feasible deployment plans comprises:
identifying a plurality of partial deployment plans;
identifying feasible partial deployment plans from the plurality of partial deployment plans based on the QoS metric;
identifying a subset of the feasible partial deployment plans based on availability of computer resources of nodes to run operators for each of the plans;
selecting one or more of the subset of feasible partial deployment plans to optimize a service provider metric; and
storing the selected plans.

3. The method of claim 2, wherein identifying a plurality of partial deployment plans comprises identifying a plurality of partial deployment plans at a leaf node for the query; and
forwarding the partial deployment plans determined to be feasible downstream to nodes to host operators in the partial deployment plans along with metadata used by the downstream nodes to expand the partial deployment plans with placements of its locally executed operators and to quantify an impact of the placements on the QoS metric.

4. The method of claim 3, wherein identifying a plurality of partial deployment plans at a leaf node for the query comprises performing a k-ahead search to determine an impact on the QoS metric to provide a best placement of k downstream operators.

5. The method of claim 4, wherein the k-ahead search comprises:
for each partial deployment plan, identifying candidate nodes to host an operator in the partial deployment plan;
sending a request to a node hosting a downstream operator asking for a second set of candidate hosts for the downstream operator and an estimate of the QoS metric for the candidates;
evaluating whether the QoS metric constraint is violated for each of the candidate nodes; and
repeating the steps of sending a request and evaluating the QoS metric for subsequent downstream operators to determine partial plans that do not violate the QoS metric constraint.

6. The method of claim 3, wherein identifying a subset of the feasible partial deployment plans comprises:
at each of the downstream nodes, determining whether the node has sufficient available computer resources to host the operator;
estimating the impact of the partial plan based on the QoS metric; and
only propagating partial plans downstream that satisfy the QoS metric constraint.

7. The method of claim 6, wherein selecting one or more of the subset of feasible partial deployment plans to optimize a service provider metric comprises:
maintaining statistics on the service provider metric for all the upstream operators of every local operator; and
selecting one or more of the subset of feasible partial deployment plans to store based on the statistics.

8. The method of claim 1, wherein determining whether a QoS metric constraint for the query is violated comprises:
each node in the query monitoring the QoS metric for its operator to the location of its publisher;
each node determining whether the QoS metric constraint is violated based on the monitoring of the QoS metric.

9. The method of claim 8, wherein each node determining whether the QoS metric constraint is violated comprises:
for each node, determining the QoS metric for all queries sharing the operator hosted on the node;
determining whether a tolerance for the QoS metric is violated for any of the queries.

10. The method of claim 1, wherein selecting a deployment plan from the set of feasible deployment plans to be used for providing the service in response to determining the QoS metric constraint is violated comprises:
selecting one or more deployment plans from the set of deployment plans that at least improves the QoS metric such that the QoS metric constraint is not violated;
from the one or more deployment plans, removing any deployment plans that do not migrate at least one operator in a bottleneck link; and
selecting one of the one or more deployments plans not removed based on a service provider metric.

11. The method of claim 10, wherein selecting one or more deployment plans comprises selecting one or more deployment plans from a set of feasible deployment plans stored on a node hosting an operator in the query that detects the QoS metric constraint violation, and if the node cannot identify one or more of deployment plans from the set of feasible deployment plans that improves the QoS metric such that the QoS metric constraint is not violated, the node sends a request to downstream nodes to identify a deployment plan that improves the QoS metric such that the QoS metric constraint is not violated.

12. A method of resolving conflicts to deploy a deployment plan for a query in a distributed stream processing system, the method comprising:
determining a new deployment plan for an existing query should be applied;
for each operator in the new deployment plan, locking the operator unless the operator is already locked;
if the operator is already locked, determining whether a conflict exists;
if a conflict exists, identifying an alternative deployment plan;
if a conflict does not exist, replicating the operator and deploying the new deployment plan.

13. The method of claim 12, wherein locking an operator comprises:
a node determining to apply the new deployment plan sending a request to lock to its publishers and subscribers for the query; and
each node receiving the request sends the request to subscribers of its operator for the query.

14. The method of claim 13, wherein nodes receiving the request, lock a local operator for the query if the operator is not already locked, wherein locking the operator prevents the node from allowing another migration of the locked operator until the lock is released.

15. The method of claim 12, wherein a conflict is operable to exist if the query has direct or indirect dependencies with another query, wherein the direct dependency is based on whether the query and the another query share an operator and the indirect dependency is when no operator is shared by the query and the another query, but there exists a third query with which both the query and the another query share an operator.

16. A computer readable storage medium storing software including instructions that when executed perform a method comprising:
creating partial deployment plans for a query currently deployed in an overlay network providing end-to-end overlay paths for data streams in a distributed stream processing system;
storing statistics on bandwidth consumed by an upstream operator of a local operator for the query;
storing statistics on query latency up to the local operator;
for each partial deployment plan, evaluating differences between the bandwidth consumed and latency for the partial deployment plan versus the currently deployed query; and
for each partial deployment plan, storing the partial deployment plan and metadata for subsequent evaluation of the partial deployment plan if the evaluated differences indicate that the partial deployment plan is better than the deployed query and the partial deployment plan satisfies a QoS metric constraint.

17. The computer readable medium of claim 16, wherein the query comprises a plurality of operators hosted by nodes in the overlay network and each of the nodes creates, evaluates and stores partial deployment plans that together form a plurality of pre-computed deployment plans for the query.

18. The computer readable medium of claim 17, wherein the method comprises:
determining whether the query latency is greater than a threshold; and
selecting one of the pre-computed deployment plans to deploy in the overlay network.

19. The computer readable medium of claim 18, wherein the selected pre-computed deployment plan includes migration of an operator for the query to a new node in the overlay network.

20. The computer readable medium of claim 19, wherein the method comprises:
prior to migrating the operator to a new node, determining whether the new node has sufficient available computer resource capacity to support a load of the operator based on estimated load of the operator and current load of the new node hosting operators for other queries.
